(19) United States
(12) Patent Application Publication
(10) Pub. No.: US 2022/0358435 A1
(43) Pub. Date: Nov. 10, 2022

(54) STANDARD TIME ESTIMATION DEVICE AND METHOD

(71) Applicant: Hitachi, Ltd., Tokyo (JP)

(72) Inventors: Ki Tae KIM, Tokyo (JP); Takanori MORITOMO, Tokyo (JP)

(73) Assignee: Hitachi, Ltd., Tokyo (JP)

(21) Appl. No.: 17/691,627

(22) Filed: Mar. 10, 2022

(30) Foreign Application Priority Data
Apr. 21, 2021 (JP) 2021-071595

(51) Int. Cl. G06Q 10/06

(52) U.S. Cl. CPC G06Q 10/06313

(57) ABSTRACT

Proposed are a standard time estimation device and a standard time estimation method capable of estimating the standard time accurately and quickly, which in turn can speed up and facilitate the planning work of a production plan. With this device and method, attributes of a product are grouped into a group that carries a meaning by the attributes being combined, and all combinations of values of each of the attributes configuring the group are extracted as a pattern from a past manufacture track record, for each of the patterns, a representative value of a real operating time is respectively calculated based on the past manufacture track record, a standard time is learned based on the representative value for each of the calculated patterns, and the standard time of the product is learned based on a learning result.

### TECHNICAL FIELD

The present invention relates to a standard time estimation device and method and, for example, can be suitably applied to a standard time estimation system which estimates the standard time of new products.

### BACKGROUND ART

Conventionally, in the planning work of a production plan in a factory or the like, the preparation of master data such as the standard time, yield and equipment allocation candidates is foremost performed. Here, “standard time” refers to the work time required for producing a certain product. Conventionally, this kind of standard time was estimated by an expert based on his/her past experience.

Nevertheless, according to this kind of conventional method, there is a problem in that it takes a relatively long time to estimate the standard time, labor costs are required for the estimation, and productivity of the expert will decrease during that period. Since this kind of problem was particularly notable in factories engaged in high-mix low-volume production, a solution to this kind of problem was desired.

Note that PTL 1 discloses a method of referring to the attribute values of work performed in the past, and utilizing a statistical method to estimate, as the standard time, the work time required for performing work such as maintenance.

### CITATION LIST

### Patent Literature

[PTL 1] Japanese Unexamined Patent Application Publication No. 2015-148961

### SUMMARY OF THE INVENTION

### Problems to be Solved by the Invention

Meanwhile, in the example disclosed in PTL 1, for instance, when there are differences in the attribute values of various attributes, such as the type (model) and quantity of equipment installed in each branch office, that will affect the maintenance work, the time required for maintenance will vary depending on the combination of attribute values such as the branch office and the model and quantity of equipment.

Nevertheless, since PTL 1 gives no consideration to the above and the attributes of work are handled independently, there was a problem in that the standard time could not be estimated accurately.

Moreover, according to the method disclosed in PTL 1, since the standard time is estimated based on the past track record, there was also a problem in that the standard time could not be estimated, or only an extremely rough estimate could be performed, for work requiring a new attribute.

The present invention was devised in view of the foregoing points, and an object of the present invention is to propose a standard time estimation device and method capable of estimating the standard time accurately and quickly, which in turn can speed up and facilitate the planning work of a production plan.

### Means to Solve the Problems

In order to achieve the foregoing object, the present invention provides a standard time estimation device which estimates a work time required for producing a product as a standard time of the product, comprising: a patterning processing unit which groups attributes of the product into a group that carries a meaning by the attributes being combined, and extracts all combinations of values of each of the attributes configuring the group as a pattern from a past manufacture track record; a representative value calculation unit which respectively calculates, for each of the patterns, a representative value of a real operating time based on the past manufacture track record; a learning unit which learns the standard time based on the representative value for each of the patterns calculated by the representative value calculation unit; and an estimation unit which estimates the standard time of the product based on a learning result of the learning unit.

The present invention additionally provides a standard time estimation method in a standard time estimation device which estimates a work time required for producing a product as a standard time of the product, comprising: a first step of grouping attributes of the product into a group that carries a meaning by the attributes being combined, and extracting all combinations of values of each of the attributes configuring the group as a pattern from a past manufacture track record; a second step of respectively calculating, for each of the patterns, a representative value of a real operating time based on the past manufacture track record; a third step of learning the standard time based on the representative value for each of the calculated patterns; and a fourth step of estimating the standard time of the product based on a learning result.

According to the standard time estimation device and method of the present invention, since it is possible to perform learning of the standard time by giving consideration to the combination of attributes and estimate the standard time of new products based on the learning result, it is possible to estimate the standard time more accurately. Moreover, according to the standard time estimation device and method of the present invention, the standard time can be estimated without any manual intervention.

### Advantageous Effects of the Invention

According to the present invention, it is possible to realize a standard time estimation device and method capable of estimating the standard time accurately and quickly, which in turn can speed up and facilitate the planning work of a production plan.

### BRIEF DESCRIPTION OF DRAWINGS

FIG. 1 is a block diagram showing an overall configuration of the standard time estimation system according to this embodiment.

FIG. 2 is a block diagram showing a schematic configuration of the customer database.

FIG. 3 is a diagram showing a configuration example of the order table.

FIG. 4 is a diagram showing a configuration example of the equipment table.

FIG. 5 is a diagram showing a configuration example of the tool table.

FIG. 6 is a diagram showing a configuration example of the material table.

FIG. 7 is a diagram showing a configuration example of the track record table.

FIG. 8A is a diagram showing a configuration example of the specification/track record table and the initial standard time estimation table.

FIG. 8B is a diagram showing a configuration example of the standard time estimation table after the addition of columns.

FIG. 9 is a diagram explaining the standard time estimation formula.

FIG. 10 is a diagram explaining the grouping of the designated attributes.

FIG. 11A and FIG. 11B are diagrams explaining the method of deciding the representative value of the designated attribute group.

FIG. 12A and FIG. 12B are diagrams showing a configuration of the group table.

FIG. 13 is a diagram explaining the method of estimating the standard time according to the grouping of the designated attributes.

FIG. 14 is a diagram explaining the method of estimating the standard time according to the grouping of the designated attributes.

FIG. 15A and FIG. 15B are diagrams explaining the data processing in a preprocessing phase.

FIG. 16 is a diagram explaining the data processing definition.

FIG. 17 is a diagram explaining the grouping definition.

FIG. 18 is a diagram explaining the estimation formula variable definition.

FIG. 19 is a diagram explaining the record to be learned definition.

FIG. 20 is a diagram explaining the standard time estimation formula file.

FIG. 21 is a flowchart showing the processing routine of the standard time estimation processing.

FIG. 22 is a flowchart showing the processing routine of the grouping processing.

### DESCRIPTION OF EMBODIMENTS

An embodiment of the present invention is now explained in detail with reference to the appended drawings.

### (1) Configuration of Standard Time Estimation System According to this Embodiment

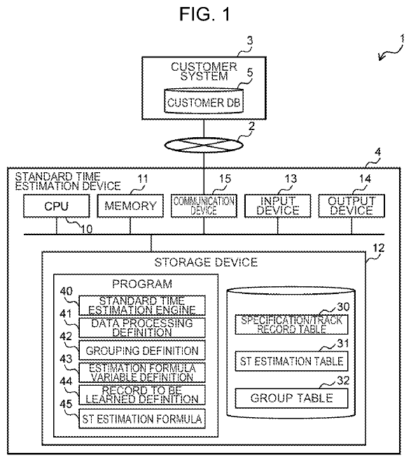

In FIG. 1, reference numeral 1 shows the overall standard time estimation system according to this embodiment. The standard time estimation system 1 is configured by comprising a customer system 3 and a standard time estimation device 4 connected via a network 2 such as the internet.

The customer system 3 is a computer device owned by a customer who places an order with a factory or the like for the manufacture of products and is configured, for example, from a general-purpose server device. The customer system 3 stores and retains, in a customer database 5, various types of information related to the specification and track record of the products for which the customer has placed orders in the past.

The standard time estimation device 4 is a computer device having a function which estimates a standard time of a new product for which an order has been placed by a customer (this is hereinafter referred to as the “standard time estimation function”), and is configured by comprising a CPU (Central Processing Unit) 10, a memory 11, a storage device 12, an input device 13, an output device 14 and a communication device 15.

The CPU 10 is a processor having a function which integrally controls the operation of the overall standard time estimation device 4. Moreover, the memory 11 is configured, for example, from a volatile semiconductor memory, and is used as a working memory of the CPU 10. The storage device 12 is configured, for example, from a non-volatile large capacity storage device such as a hard disk device or an SSD (Solid State Drive), and stores various programs and various types of data to be retained for a long period.

The programs stored in the storage device 12 are read into the memory 11 when the standard time estimation device 4 is activated or as needed, and the various types of processing as the overall standard time estimation device 4 are executed as described later by the programs read into the memory 11 being executed by the CPU 10.

The input device 13 is a device that is used by a user for inputting necessary information and instructions, and is configured, for example, from a mouse, a keyboard or the like. Moreover, the output device 14 is configured from a liquid crystal panel, an organic EL (Electro-Luminescence) panel or the like, and is used for displaying necessary information and various screens. Note that the input device 13 and the output device 14 may also be configured from a touch panel integrating these devices.

The communication device 15 is configured, for example, from an NIC (Network Interface Card), and functions as an interface when communicating with the customer system 3 via the network 2.

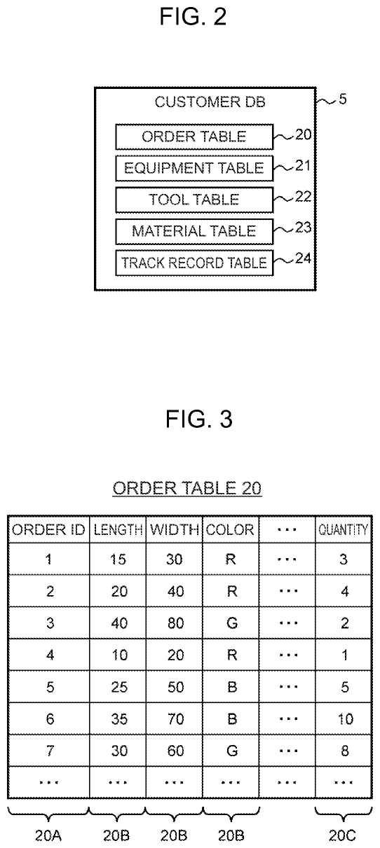

Note that a configuration example of the customer database 5 retained by the customer system 3 is shown in FIG. 2. As shown in FIG. 2, the customer database 5 is configured by comprising an order table 20, an equipment table 21, a tool table 22, a material table 23 and a track record table 24.

The order table 20 is a table that is used by the customer for storing and retaining past order details, and is configured by comprising, as shown in FIG. 3, an order ID column 20A, a plurality of specification columns 20B and a quantity column 20C. In the order table 20, one record (row) corresponds to one order placed in the past.

The order ID column 20 stores an identifier (order ID) unique to the corresponding order that is assigned to that order. Moreover, each specification column 20B stores the specification such as length, width or color of the ordered product other than the material of that product, and the quantity column 20C stores the quantity of the ordered product.

Accordingly, in the example of FIG. 3, the order details of the order to which “1” has been assigned as the order ID show that, in the least, an order for “3” products having a length of “15”, a width of “30” and a color of “red (R)” will be placed.

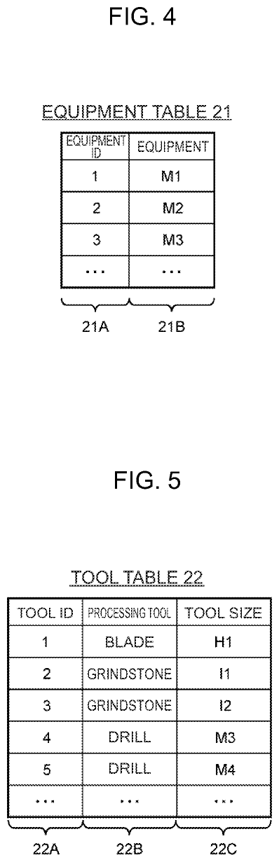

Moreover, the equipment table 21 is a table that is used for managing the equipment installed in the supplier's factory or the like, and is configured by comprising, as shown in FIG. 4, an equipment ID column 21A and an equipment column 21B. In the equipment table 21, one record (row) corresponds to one piece of equipment installed in the supplier's factory or the like.

The equipment ID column 21A stores an identifier (equipment ID) unique to the corresponding equipment that is assigned to that equipment, and the equipment column 21B stores the equipment name (model name or the like) of the corresponding equipment.

Accordingly, the example of FIG. 4 shows that the equipment name of the equipment to which “1” has been assigned as the equipment ID is “M1”, the equipment name of the equipment to which “2” has been assigned as the equipment ID is “M2”, and the equipment name of the equipment to which “3” has been assigned as the equipment ID is “M3”.

The tool table 22 is a table that is used for managing the processing tools equipped in the supplier's factory or the like, and is configured by comprising, as shown in FIG. 5, a tool ID column 22A, a processing tool column 22B and a tool size column 22C. In the tool table 22, one record (row) corresponds to one type of processing tool equipped in the supplier's factory or the like.

The tool ID column 22A stores an identifier (tool ID) unique to the corresponding processing tool that is assigned to that processing tool, and the processing tool column 22B stores the type of processing tool such as “blade”, “grindstone”, “drill” or the like. Moreover, the tool size column 22C stores a size representing the diameter, roughness or the like of the corresponding processing tool.

Accordingly, the example of FIG. 5 shows that the type of processing tool to which “1” has been assigned as the tool ID is “blade”, and the size of the corresponding processing tool is “H1”.

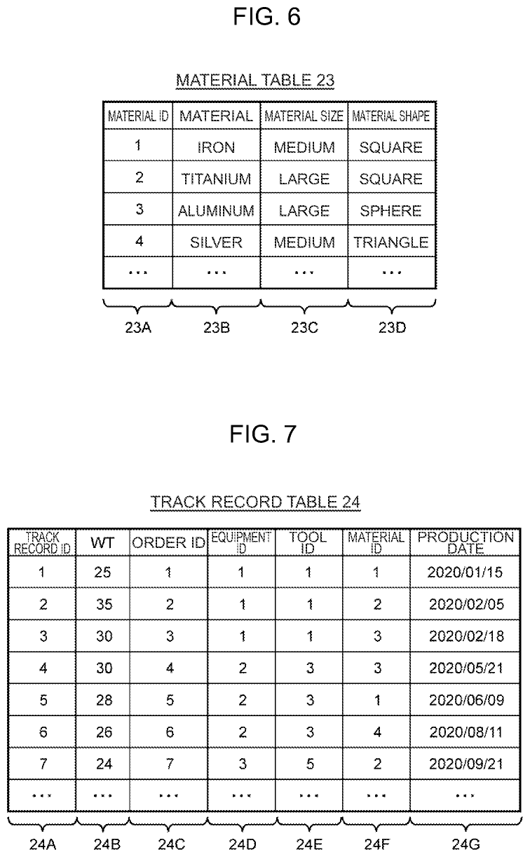

The material table 23 is a table that is used for managing the materials available for use as the material of the product, and is configured by comprising, as shown in FIG. 6, a material ID column 23A, a material column 23B, a material size column 23C and a material shape column 23D. In the material table 23, one record (row) corresponds to one type of material that is available for use as the material of the product.

The material ID column 23A stores an identifier (material ID) unique to the corresponding material that is assigned to that material, and the material column 23B stores a name of the material such as “iron”, “titanium” or the like. Moreover, the material size column 23C stores a size of the corresponding material before being processed. In the case of this embodiment, the size of the material is expressed as one among “large”, “medium” and “small”. Furthermore, the material shape column 23D stores a shape of the corresponding material before being processed (“square”, “triangle”, “sphere” or the like).

Accordingly, the example of FIG. 6 shows that “1” has been assigned as the material ID to the material of “iron”, the unprocessed size of that material is “medium”, and the unprocessed shape of that material is “square”.

The track record table 24 is a table that is used for managing, as track record data, information of the track record of orders previously placed by the customer, and is configured by comprising, as shown in FIG. 7, a track record ID column 24A, a working time column 24B, an order ID column 24C, an equipment ID column 24D, a tool ID column 24E, a material ID column 24F and a production date column 24G. In the track record table 24, one record (row) corresponds to one track record data (one order track record).

The track record ID column 24A stores an identifier (track record ID) unique to the corresponding order track record that is assigned to that order track record, and the order ID column 24C stores an order ID of the order corresponding to that order track record. Moreover, the working time column 24B stores real operating time (this is hereinafter referred to as the “working time”) required for manufacturing the corresponding product.

Furthermore, the equipment ID column 24D stores an equipment ID of the equipment that manufactured the corresponding product, and the tool ID column 24E stores a tool ID of the processing tool that was used in the equipment. Moreover, the material ID column 24F stores a material ID of the material that was used for manufacturing the product, and the production date column 24G stores a date on which the corresponding product was produced.

Accordingly, the example of FIG. 7 shows that the order track record to which “1” has been assigned as the order track record ID is related to the order to which “1” has been assigned as the order ID, working time of “25” hours was required for manufacturing the product from a material having a material ID of “1” using equipment having an equipment ID of “1” equipped with a tool having a tool ID of “1”, and the production date of that product was “2020/01/15”.

### (2) Standard Time Estimation Function According to this Embodiment

The standard time estimation function equipped in the standard time estimation device 4 is now explained. The standard time estimation function is, as described above, a function which estimates a standard time of a new product for which an order has been placed by a customer. In the case of this embodiment, the series of processing (this is hereinafter referred to as the “standard time estimation processing”) for estimating the standard time that is each executed for each process based on the standard time estimation function is composed of the following three phases; namely, a preprocessing phase, a learning phase and an operation phase.

The preprocessing phase is a phase of performing the preprocessing of “learning” which is executed in the learning phase described later. In effect, the standard time estimation device 4 foremost acquires, in the preprocessing phase, data of various attributes that may be related to the working time during the manufacture of the product such as “length”, “width”, “color”, “equipment”, “processing tool”, “processing size”, “material shape” and “working time” among the various types of data stored in the customer database 5 (FIG. 1, FIG. 2). The attributes for which data is to be acquired above are respectively designated by the user in advance for each process. In the following explanation, the attributes designated by the user for which data is to be acquired are hereinafter referred to as the “designated attributes”.

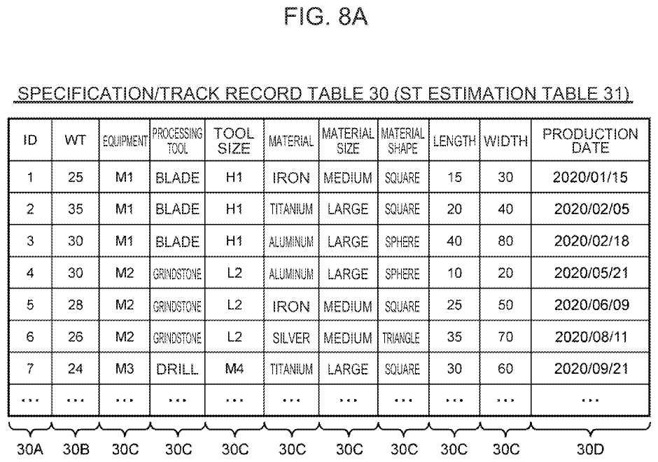

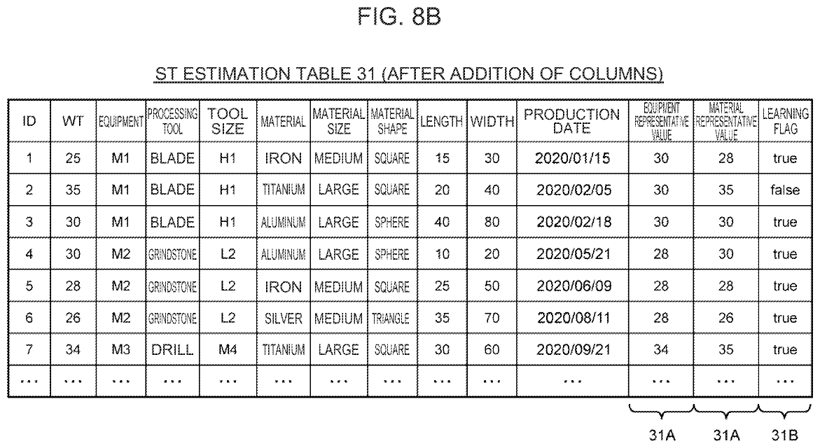

Moreover, the standard time estimation device 4 creates a specification/track record table 30 as shown in FIG. 8A for each process based on the data of each of the designated attributes that were acquired. The specification/track record table 30 is a table that summarizes, for each order, data of each of the designated attributes that were acquired as described above, and is configured by comprising a track record ID column 30A, a working time column 30B, a plurality of designated attribute columns 30C, and a production date column 30D. In the specification/track record table 30, one record (row) corresponds to one order track record of an order placed by the customer in the past.

The track record ID column 30A stores a track record ID of the corresponding order track record, and the working time column 30B stores the working time required for manufacturing one of the ordered products. Moreover, each designated attribute column 30C stores a value of the corresponding designated attribute related to the specification or the like acquired by the standard time estimation device 4 from the customer database 5 (FIG. 1, FIG. 2) regarding that order track record. Furthermore, the production date column 30D stores the production date of that product.

Subsequently, in the preprocessing phase, the standard time estimation device 4 creates a standard time estimation table 31 (hereinafter referred to as the “ST (Standard Time) estimation table” in the drawings) by directly copying the created specification/track record table 30, and performs predetermined processing such as removing outliers from data of each designated attribute registered in the created standard time estimation table 31 or integrating values having the same or similar characteristics (for example, iron and aluminum) in relation to the working time of a certain designated attribute (for example, material). Moreover, the standard time estimation device 4 performs the patterning processing described later based on the data of each designated attribute after processing.

Meanwhile, the learning phase is a phase of learning the working time of each specification of the product for each process by using the standard time estimation table 31 for each process created in the preprocessing phase. In the case of this embodiment, the standard time estimation device 4 learns the standard time by using multi-regression analysis.

Learning of the standard time using multi-regression analysis is performed in the following manner. Specifically, a plurality of simultaneous equations are created by assigning the track record value of each corresponding designated attribute of the same record in the standard time estimation table 31 to x_{attribute 1}, x_{attribute 2}, . . . , x_{attribute n} of the arithmetic expression given in the following formula (this is hereinafter referred to as the “standard time estimation formula”) with the standard time to be obtained as ST:

[Math 1]

ST= [symbol] · [symbol] + [symbol] · [symbol] + . . . + [symbol] ·x [symbol] +c (1)

ST=α_{attribute 1}·x_{attribute 1}+α_{attribute 2}*x_{attribute 2}+ . . . +α_{attribute n}·x_{attribute n}+c (1)

and respectively obtaining the coefficient values α_{attribute 1}, α_{attribute 2}, . . . , α_{attribute n}, and the value of the intercept c thereof, for each designated attribute so that the prediction error of the simultaneous equation becomes minimum.

In the foregoing case, according to this kind of learning method, the handling of qualitative data such as “color”, “equipment”, and “tool” will become a problem, but generally the method of quantifying qualitative data using the dummy variable conversion technique is adopted.

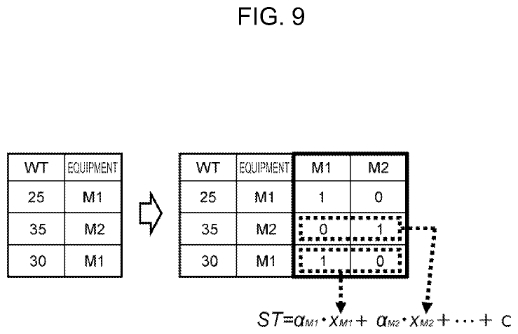

For example, as shown in FIG. 9, with regard to the designated attribute of “equipment”, the numerical value of “10” consisting of the two flag values of “1” and “0” is assigned to the equipment having the equipment name of “M1”, the numerical value of “01” consisting of the two flag values of “0” and “1” is assigned to the equipment having the equipment name of “M2”, and these numerical value are used as the track record values of the qualitative data.

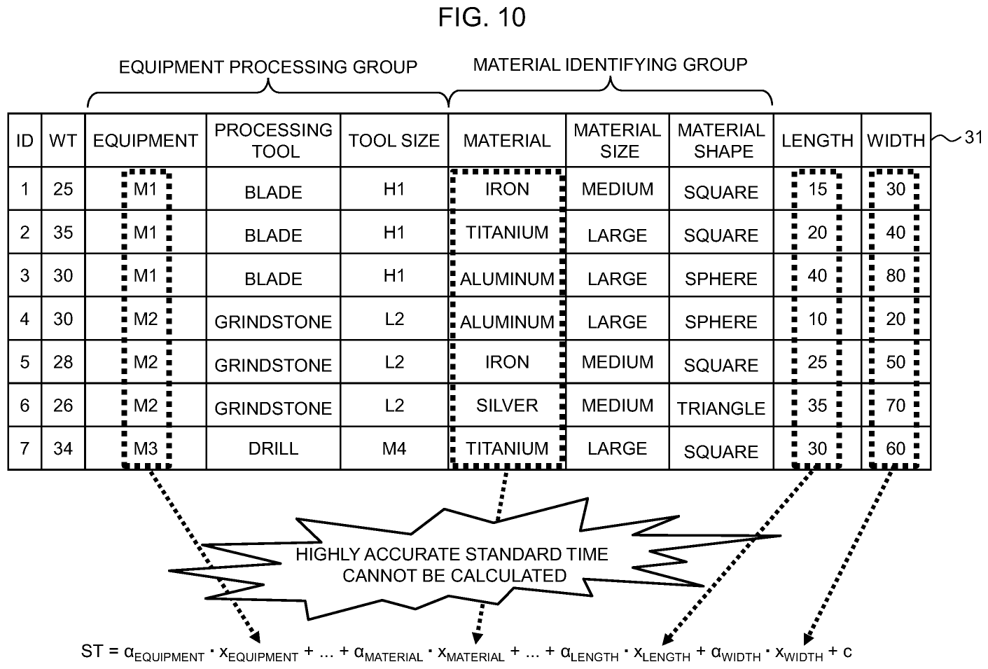

Meanwhile, among the various attributes related to the specification or the like of the product, certain attributes have a weak relation with the working time independently, but have a stronger relation with the working time when combined with another attribute. For example, as shown in FIG. 10, while attributes such as “equipment”, “processing tool”, “tool size”, “material”, “material size” and “material shape” have a weak relation with the working time independently, it is empirically known that the combination of “equipment”, “processing tool” and “tool size” and the combination of “material”, “material size” and “material shape” have a strong relation with the working time. Accordingly, even if the respective attributes of “equipment”, “processing tool”, “tool size”, “material”, “material size” and “material shape” are individually handled in the standard time estimation formula, it is not possible to calculate a highly accurate standard time.

Thus, for a designated attribute group that carries a meaning (that is, has a strong relation with the working time) based on a combination, the standard time estimation device 4 groups and manages the respective designated attributes configuring the designated attribute group as one group. For example, in the foregoing example, the standard time estimation device 4 manages the respective designated attributes of “equipment”, “processing tool” and “tool size” as one “equipment processing group”, and manages the respective designated attributes of “material”, “material size” and “material shape” as one “material property group”.

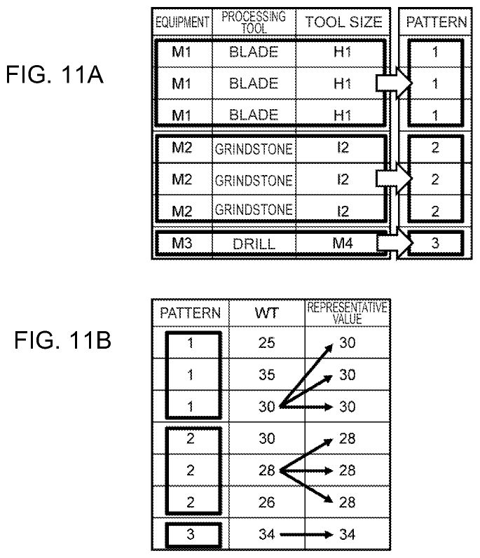

Moreover, the standard time estimation device 4 refers to the corresponding standard time estimation table 31, extracts, as one pattern, a combination in which the respective designated attributes in that group have the same value as shown in FIG. 11A for each group, and, as shown in FIG. 11B, maps, to each pattern, a median value of the working time in the past order track record having the same pattern as that pattern as a representative value of that pattern. The reason why the median value is mapped as the representative value is because it is approximate to the average value and also strong against noise.

For example, in the case of FIG. 11A, the standard time estimation device 4 extracts, each as a pattern, those in which the combination of the values of “equipment”, “processing tool” and “tool size” is “M1”, “blade” and “H1”; “M2”, “grindstone” and “I2”; and “M3”, “drill” and “M4”. Moreover, for example, for the pattern of “M1”, “blade” and “H1”, since the working time of that pattern in the order track record is “25”, “35” and “30”, respectively, the standard time estimation device 4 maps “30”, which is the median value thereof, as the representative value of that pattern.

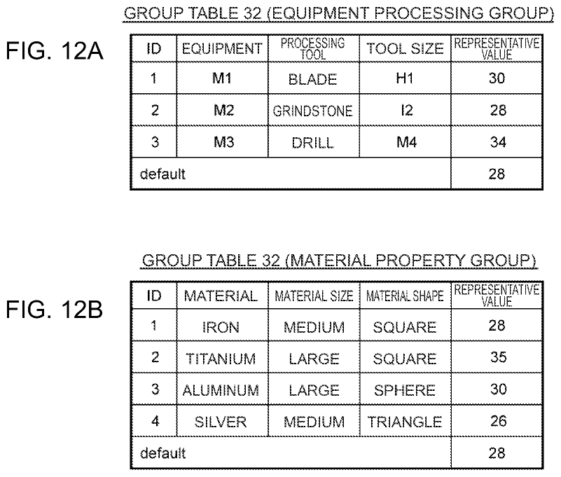

Subsequently, the standard time estimation device 4 creates a group table 32 as shown in FIG. 12A and FIG. 12B for each group based on the mapping result, and manages the representative value of each pattern in the group for each group.

Moreover, as shown in FIG. 8B, the standard time estimation device 4 adds, to the standard time estimation table 31, a column (representative value column 31A) for each group for storing the representative value, and stores, for each record, the representative value of each group in that record in the corresponding representative value column 31A in that record.

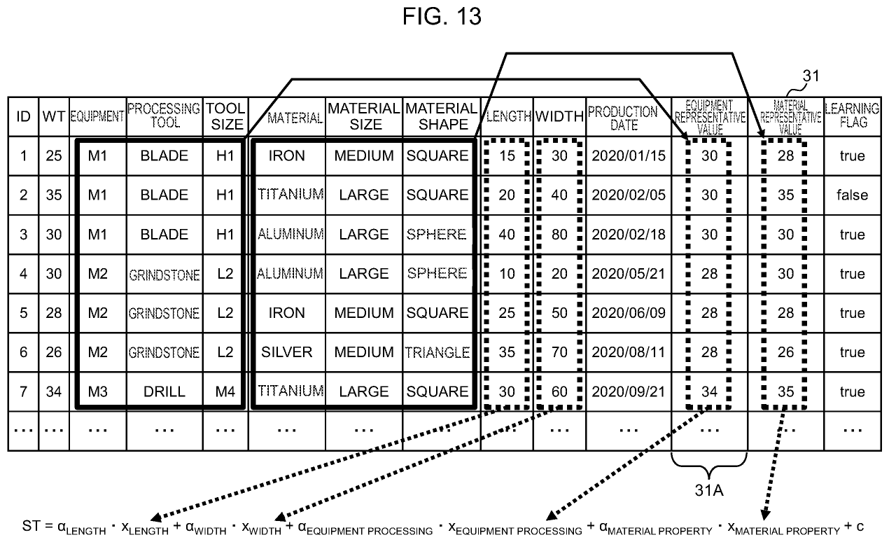

Subsequently, as shown in FIG. 13, the standard time estimation device modifies the standard time estimation formula given in Formula (1) into a standard time estimation formula such as the following formula which compiles each term of each designated attribute belonging to that group into one term corresponding to that group for each group:

[Math 2]

ST= [symbol] · [symbol] + [symbol] · [symbol] + . . . + [symbol] · [symbol] + [symbol] ₊₁· [symbol] ₊₂= . . . +c (2)

ST=α_{group 1}·x_{group 1}+α_{group 2}·x_{group 2}+ . . . +α_{attribute p}·x_{attribute p}+α_{attribute p+1}·x_{attribute p+2}+ . . . +c (2)

and learns the relation of the specification or the like of the product and the working time by assigning the representative value of the corresponding pattern of the group corresponding to “one term of the group” (that is, obtains the value of each coefficient α and the value of the intercept c, respectively).

Note that, in Formula (2), α_{group 1}, α_{group 2}, . . . each represent the coefficient value of group 1, group 2, . . . , and α_{attribute p}, α_{attribute p+1}, . . . each represent the coefficient value of the remaining attribute p, attribute p+1, . . . that have not been grouped.

Furthermore, with the standard time estimation device 4 of this embodiment, by designating the production period in advance, the records to be learned in the learning phase can be limited among the respective records registered in the standard time estimation table 31.

Thus, as shown in FIG. 8B, a learning flag column 31B storing a learning flag is added to the standard time estimation table 31, and, for the records corresponding to the order track record during the designated production period, the learning flag of the learning flag column 31B is set to “true” which means that the record should be used in the learning, and, for the records corresponding to the order track record outside the designated production period, the learning flag of the learning flag column 31B is set to “false” which means that the record should not be used in the learning.

By being able to limit the order track records to be used in the learning from the information of the order track records registered in the standard time estimation table 31, it is possible to cause the standard time estimation device 4 to perform the learning by using only the information of the order track records during the desired production period.

Meanwhile, the operation phase is a phase of estimating a standard time of a new product based on the learning result in the learning phase. The standard time estimation device 4 calculates the standard time ST by respectively assigning the corresponding values according to the specification of the new product to the standard time estimation formula for which the coefficients α and the intercept c were obtained for each designated attribute based on the learning in the learning phase (for example, when there is no group, assigned to x_{attribute 1}, x_{attribute 2}, . . . , x_{attribute n} in the standard time estimation formula given in Formula (1)).

Based on the series of processing described above, it is possible to calculate the standard time with even greater accuracy.

By way of reference, in the operation phase, there may be cases where certain specifications of a new product are entirely new specifications, and the representative value of the corresponding pattern of the group corresponding to such certain specifications has not yet been obtained. For example, there may be cases where the combination of the values of “equipment”, “processing tool” and “tool size” in the new product does not coincide with any of the patterns of the “equipment processing group” created based on the past order track records.

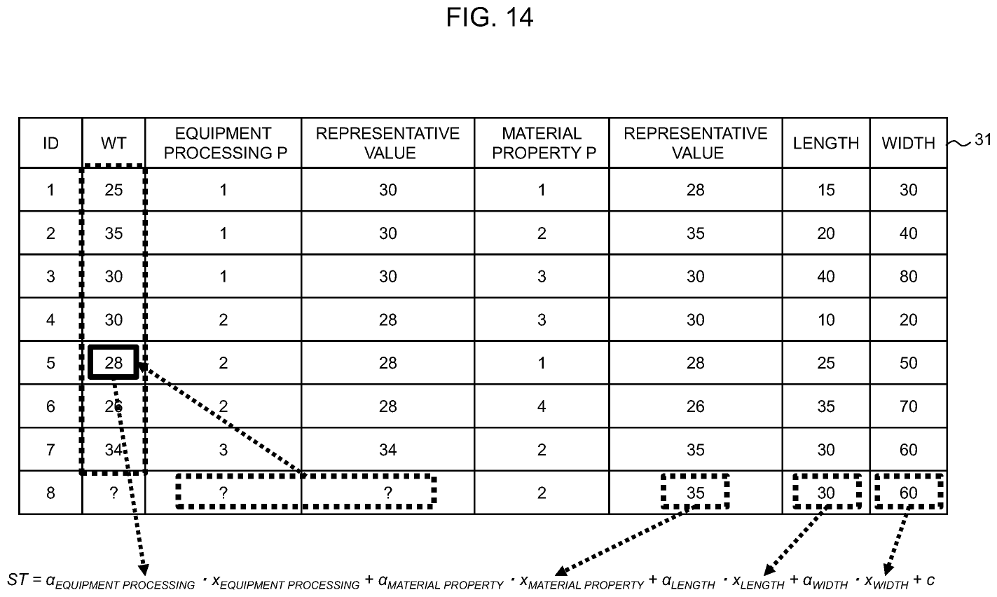

In order to deal with the foregoing case, as shown in FIG. 14, the standard time estimation device 4 selects, as the representative value of the new pattern, the median value of the working time in all order track records registered in advance in the standard time estimation table 31 of FIG. 8A. The reason why the median value is selected as the representative value is because it is approximate to the average value and also strong against noise.

Subsequently, the standard time estimation device 4 manages the selected representative value by registering it, as the default value (“default”) of the corresponding group, in the corresponding group table 32 (FIG. 12A and FIG. 12B) and the standard time estimation table 31 (FIG. 8B), and calculates the standard time of that new product by using the representative value as the track record value of that new pattern.

Based on this kind of method, even when a specification of a new product is an entirely new specification, it is possible to calculate a standard time of that product while maintaining a certain level of accuracy.

As a means for realizing the standard time estimation function of this embodiment described above, the storage device 12 of the standard time estimation device 4 stores a standard time estimation engine 40 as a program as shown in FIG. 1, and stores, as data used by the standard time estimation engine 40, one or more data processing definitions 41, one or more grouping definitions 42, an estimation formula variable definition 43, a record to be learned definition 44, and a standard time estimation formula file 45.

The standard time estimation engine 40 is software having a function which executes the foregoing series of standard time processing. More specific functions of the standard time estimation engine 40 will be described later.

Moreover, the data processing definition 41 is a definition which prescribes the processing contents upon performing the predetermined data processing in the foregoing preprocessing phase. In the case of this embodiment, as the foregoing data processing, in addition to the removal of outliers, the processing of integrating the plurality of values in the same designated attributes having the same or similar characteristics relative to the working time into a single value is performed.

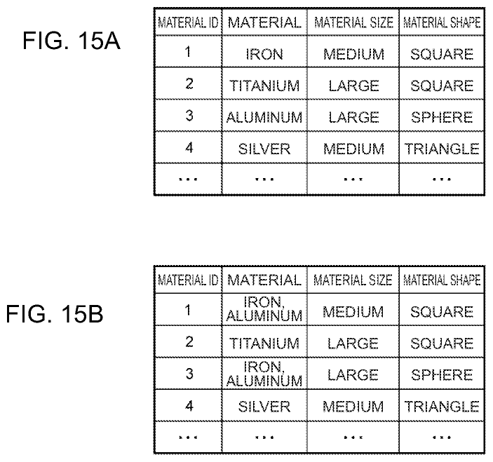

For example, in the example of FIG. 15A, when the working time is the same or nearly the same when the materials are “iron” and “aluminum” irrespective of the type of product that is produced, as shown in FIG. 15B, the materials “iron” and “aluminum” are integrated as one value (“iron, aluminum”), and the data processing definition 41 prescribes this kind of rule. The data processing definition 41 is prepared for each content of the data processing.

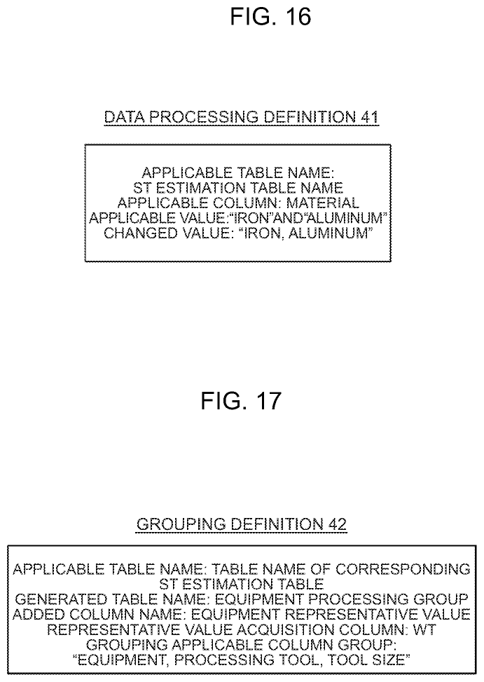

In the data processing definition 41, as shown in FIG. 16, “applicable table name”, “applicable column”, “applicable value” and “changed value” are defined. The “applicable table name” is a table name of the standard time estimation table 31 to which the data processing definition 41 is applied, and the “applicable column” is a column corresponding to the target attribute in the standard time estimation table 31. Moreover, the “applicable value” is each value to be integrated in that attribute, and the “changed value” is a value after the integration of these values.

Moreover, the grouping definition 42 is a definition of the designated attribute group to be grouped that is decided by the user in advance, and it is prepared for each designated attribute group (that is, for each group) to be grouped. In the grouping definition 42, as shown in FIG. 17, “applicable table name”, “generated table name”, “added column name”, “representative value acquisition column” and “grouping applicable column group” are defined.

The “applicable table name” is a table name of the standard time estimation table 31 to which the grouping definition 42 should be applied. Moreover, the “generated table name” is a table name of the group table 32 (FIG. 12A and FIG. 12B) to be generated according to the grouping definition 42, and is “equipment processing group” in the example of FIG. 12A.

The “added column name” is a column name of the column to be added to the standard time estimation table 31 for storing the processing result of the grouping processing. In the example of FIG. 17, this corresponds to “equipment representative value” as the column name of the equipment representative value column 31A to be added, as shown in FIG. 8B, to the standard time estimation table 31 of FIG. 8A.

The “representative value acquisition column” is a column name of the column to be used for acquiring the representative value of each pattern in the target group. In the example of FIG. 17, this corresponds to “working time” as the column name of the working time column 30B in the standard time estimation table 31 shown in FIG. 8A.

Furthermore, the “grouping applicable column group” is a column corresponding to each designated attribute in the standard time estimation table 31 to be grouped. In the example of FIG. 17, each designated attribute column 30C of the column names of “equipment”, “processing tool” and “tool size” in the standard time estimation table 31 of FIG. 8A is designated.

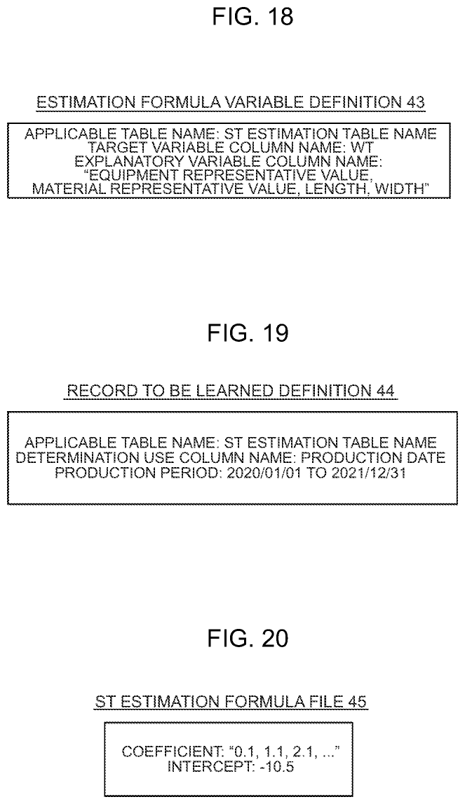

Meanwhile, the estimation formula variable definition 43 is a definition regarding the standard time estimation formula of Formula (1) or Formula (2) for estimating a standard time of a new product. In the estimation formula variable definition 43, as shown in FIG. 18, “applicable table name”, “target variable column name” and “explanatory variable column name” are defined.

The “applicable table name” is a table name of the standard time estimation table 31 to which the estimation formula variable definition 43 should be applied. Moreover, the “target variable column name” refers to a column name (normally, “working time”) of the column corresponding to the designated attribute to become the target variable in the standard time estimation formula among the respective columns of the standard time estimation table 31.

In addition, the “explanatory variable column name” is a column name of the column storing the designated attribute to become the explanatory variable in the standard time estimation formula or the representative value of the corresponding pattern in the corresponding group described above with reference to FIG. 8B, and this corresponds to “equipment representative value” or “material representative value” in the example of FIG. 8B.

The record to be learned definition 44 is a definition of the record to be used in the learning in the learning phase. In the record to be learned definition 44, as shown in FIG. 19, “applicable table name”, “determination use column name” and “production period” are defined.

The “applicable table name” is a table name of the standard time estimation table 31 to which the record to be learned definition 44 should be applied. Moreover, the “determination use column name” is a column name (in this example, “production date”) of the column to be referenced for determining whether or not to use that record in the learning, and the “production period” is a range of the value stored in the corresponding column for using that record in the learning.

In the example of FIG. 19, the learning flag of the learning flag column 31B (FIG. 8B) of the standard time estimation table 31 is set to “true” when the value stored in the production date column of the record is within the range of “2020/01/01 to 2021/12/31”, and the learning flag is otherwise set to “false”. Furthermore, only the records in which the learning flag has been set to “true” are used in the learning in the learning phase.

Note that the storage device 12 (FIG. 1) stores a standard time estimation formula file 45 in addition to the data processing definition 41, the grouping definition 42, the estimation formula variable definition 43 and the record to be learned definition 44 described above.

The standard time estimation formula file 45 is a file storing the learning result (learning model) in the learning phase, and stores the respective designated attributes or the values of the coefficients of the respective groups (α_{attribute 1}, α_{attribute 2}, . . . , α_{attribute n} of Formula (1) or α_{group 1}, α_{group 2}, . . . , α_{attribute p}, α_{attribute p+1}, . . . of Formula (2)), and the value of the intercept (for example, c of Formula (1) or Formula (2)). In the operation phase, a standard time of a new product is estimated by using the values of these coefficients and intercept.

### (3) Standard Time Estimation Function Processing

The specific processing contents of the standard time estimation processing executed by the standard time estimation device 4 based on the standard time estimation function according to this embodiment are now explained. Note that, in the following explanation, while the standard time estimation engine 40 is explained as the processing subject of the various types of processing, in effect, it goes without saying that the CPU 10 (FIG. 1) of the standard time estimation device 4 executes the processing based on the standard time estimation engine 40.

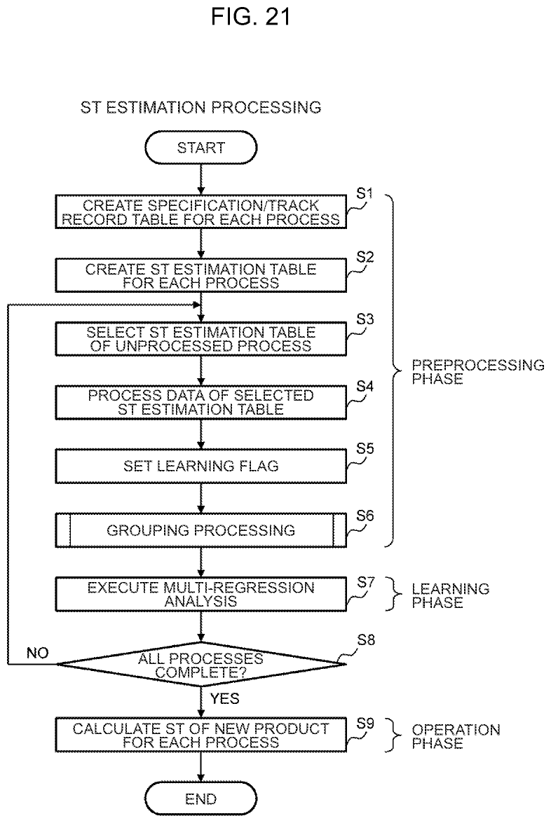

FIG. 21 shows the series of flow of the standard time estimation processing. The standard time estimation engine 40 estimates a standard time of a new product according to the processing routine shown in FIG. 21.

In effect, when a user inputs an instruction for calculating a standard time for each process together with the specification or the like of a new product via the input device 13 (FIG. 1), the standard time estimation engine 40 starts the standard time estimation processing shown in FIG. 21, and foremost accesses the customer system 3 (FIG. 1) and acquires information required for estimating a standard time for each process of a new product among the various types of information stored in the customer database 5 (FIG. 2), and creates a specification/track record table 30 (FIG. 8A) for each process based on the acquired information (S1).

Next, the standard time estimation engine 40 creates a standard time estimation table 31 for each process by copying the specification/track record table 30 created in step S1 for each process (S2), and selects a standard time estimation table 31 of one process, in which the processing of step S4 onward has not yet been performed, among the standard time estimation tables 31 created for each process (S3).

Next, the standard time estimation engine 40 performs data processing such as integrating a plurality of designated values of the designated attributes which were designated according to the data processing definition 41 (FIG. 16) regarding the standard time estimation table (this is hereinafter referred to as the “selected standard time estimation table”) 31 selected in step S3, or removing outliers (S4).

Moreover, the standard time estimation engine 40 adds a learning flag column 31B (FIG. 8B) to each record of the selected standard time estimation table 31, sequentially determines whether that record should be learned according to the record to be learned definition 44 for each record, and sets a learning flag of the learning flag column 31B of that record based on the determination result (S5).

Specifically, the standard time estimation engine 40 sets the learning flag of the learning flag column 31B of that record to “true” when it is determined that the record should be learned as described above, and sets the learning flag to “false” when it is determined that the record should not be learned.

Next, the standard time estimation engine 40 executes the grouping processing according to the grouping definition 42 (S6). Specifically, the standard time estimation engine 40 groups several designated attributes defined based on the grouping definition 42, selects the representative value of each pattern in the group, and creates a group table 32 for each group described above with reference to FIG. 12A and FIG. 12B. Moreover, the standard time estimation engine 40 adds a representative value column 31A for each group to the selected standard time estimation table 31, and stores, in the representative value column 31A, the representative value according to the pattern of the corresponding group of that record.

Next, the standard time estimation engine 40 learns the standard time based on multi-regression analysis by using the data of each record of the selected standard time estimation table 31 according to the estimation formula variable definition 43. Here, the standard time estimation engine 40 refers to the learning flag column 31B (FIG. 8B) of each record of the selected standard time estimation table 31, and performs the learning by using only the records in which the value of the learning flag is “true”. Subsequently, the standard time estimation engine 40 stores the learning result (learning model), as the standard time estimation formula file 45, in the storage device 12 (FIG. 1) (S7).

Thereafter, the standard time estimation engine 40 determines whether the processing of step S4 to step S7 has been executed for all processes (S8). Subsequently, the standard time estimation engine 40 returns to step S3 upon obtaining a negative result in the foregoing determination, and thereafter repeats the processing of step S3 to step S8 while sequentially switching the process (standard time estimation table 31) selected in step S3 to another process (standard time estimation table 31) in which the processing of step S4 onward has not yet been performed.

Subsequently, when the standard time estimation engine 40 obtains a positive result in step S8 as a result of the learning using the standard time estimation table 31 being eventually completed for all processes, the standard time estimation engine 40 estimates a standard time of a new product to be manufactured by the user for each process by using the previous learning results (that is, respective designated attributes and coefficient values of each group, and the intercept value, stored in the standard time estimation formula file 45 for each process) (S9). The standard time estimation engine 40 thereafter ends the standard time estimation processing.

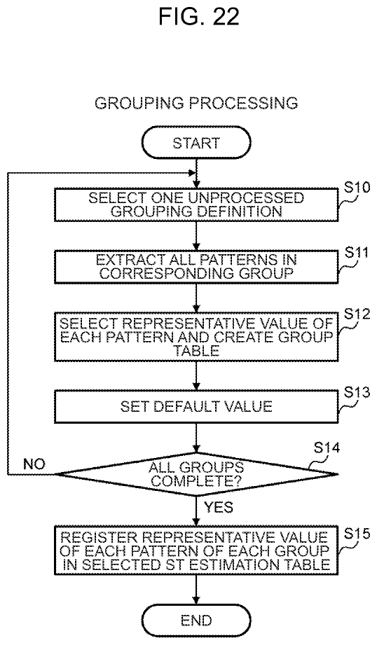

Note that the more specific processing contents of the standard time estimation engine 40 in step S6 of the standard time estimation processing are shown in FIG. 22. When the standard time estimation engine 40 proceeds to step S6 of the standard time estimation processing, the standard time estimation engine 40 starts the grouping processing shown in FIG. 22, and foremost selects a grouping definition 42 in which the processing of step S11 onward has not yet been performed among the grouping definitions 42 (FIG. 17) corresponding to the selected standard time estimation table 31 (S10).

Next, the standard time estimation engine 40 acquires the value of each column designated as the “grouping applicable column group” in the grouping definition 42 selected in step S10 for each record of the selected standard time estimation table 31, and extracts, each as a pattern, all combinations of the acquired values of each column (S11).

Next, the standard time estimation engine 40 calculates (selects) the representative value of each pattern acquired in step S11 based on the method described above with reference to FIG. 11B, and creates the group table 32 described above with reference to FIG. 12A and FIG. 12B based on the calculation (selection) result (S12). Note that, at this stage, a default value has not been set in the created group table 32.

Furthermore, the standard time estimation engine 40 registers, in the group table 32 created in step S12, a median value of the working time in all order track records registered in the standard time estimation table 31 as the default value (“default”) of the corresponding group (S13).

Next, the standard time estimation engine 40 determines whether the processing of step S11 to step S13 has been executed for all grouping definitions 42 (S14). Subsequently, the standard time estimation engine 40 returns to step S10 upon obtaining a negative result in the foregoing determination, and thereafter repeats the processing of step S10 to step S14 while sequentially switching the grouping definition 42 selected in step S10 to another grouping definition 42 in which the processing of step S11 onward has not yet been performed.

Subsequently, when the standard time estimation engine 40 obtains a positive result in step S14 as a result of the processing of step S11 to step S13 being eventually executed for all grouping definitions 42, the standard time estimation engine 40 registers in the selected standard time estimation table 31 the representative value of each pattern of each group obtained based on the repeated processing of step S10 to step S14 performed up to that point in time (S15).

Specifically, the standard time estimation engine 40 adds, to the selected standard time estimation table 31, columns for each group created as described above (equipment representative value column 31A, material representative value column 31A and so on of FIG. 8B). Moreover, the standard time estimation engine 40 determines, for each group to which columns have been added, whether a combination of the values of the designated attribute group configuring that group coincides with any pattern among the patterns extracted in the repeated processing of step S10 to step S14 while referring to the corresponding group table 32. The standard time estimation engine 40 reads the representative value of the coinciding pattern from the group table 32, and stores the representative value in the corresponding column of that record.

Subsequently, the standard time estimation engine 40 ends the grouping processing, and returns to the standard time estimation processing of FIG. 21.

### (4) Effect of Embodiment

As described above, the standard time estimation system 1 of this embodiment groups attributes of a product, extracts, for each group, all combinations of values of each of the attributes configuring the group as a pattern from a past manufacture track record, respectively calculates, for each extracted pattern, a representative value of a working time based on the past manufacture track record, learns a standard time based on the representative value for each calculated pattern, and estimates the standard time of a new product based on a learning result.

Thus, according to the standard time estimation system 1, since it is possible to learn the standard time by giving consideration to the combination of attributes having a strong relation with the working time and estimate the standard time of the new product based on the learning result, it is possible to estimate the standard time with greater accuracy. Moreover, according to the standard time estimation system 1, the standard time can be estimated without any manual intervention. Thus, according to the standard time estimation system 1, it is possible to estimate the standard time accurately and quickly, which in turn can speed up and facilitate the planning work of a production plan.

### (5) Other Embodiments

Note that, while the foregoing embodiment explained a case where one standard time estimation device 4 was equipped with the functions of a patterning processing unit which groups attributes of the product into a group that carries a meaning by the attributes being combined, and extracts all combinations of values of each of the attributes configuring the group as a pattern from a past manufacture track record, a representative value calculation unit which respectively calculates, for each of the patterns, a representative value of a real operating time based on the past manufacture track record, a learning unit which learns the standard time based on the representative value for each of the patterns calculated by the representative value calculation unit, and an estimation unit which estimates the standard time of the product based on a learning result of the learning unit, the present invention is not limited thereto, and, for example, the functions of the patterning processing unit, the representative value calculation unit, the learning unit and the estimation unit may also be distributed and mounted on a plurality of computer devices configuring a distributed computing system.

Moreover, while the foregoing embodiment explained a case where a manufacture track record of a past product is stored as one track record in the customer database 5 retained in the customer system 3, and the standard time estimation device 4 estimates a standard time of a new product based on the order track record, the present invention is not limited thereto, and the manufacture track record of a past product may also be managed by (stored and retained in) the standard time estimation device 4.

### INDUSTRIAL APPLICABILITY

The present invention can be broadly applied to a standard time estimation device of various configurations which estimates the work time required for producing a product as the standard time of the product.

### REFERENCE SIGNS LIST

1 . . . standard time estimation system, 3 . . . customer system, 4 . . . standard time estimation device, 5 . . . customer database, 10 . . . CPU, 30 . . . specification/track record table, 31 . . . standard time estimation table, 32 . . . group table, 40 . . . standard time estimation engine, 41 . . . data processing definition, 42 . . . grouping definition, 43 . . . estimation formula variable definition, 44 . . . record to be learned definition, 45 . . . standard time estimation formula file.

1. A standard time estimation device which estimates a work time required for producing a product as a standard time of the product, comprising:
a patterning processing unit which groups attributes of the product into a group that carries a meaning by the attributes being combined, and extracts all combinations of values of each of the attributes configuring the group as a pattern from a past manufacture track record;
a representative value calculation unit which respectively calculates, for each of the patterns, a representative value of a real operating time based on the past manufacture track record;
a learning unit which learns the standard time based on the representative value for each of the patterns calculated by the representative value calculation unit; and
an estimation unit which estimates the standard time of the product based on a learning result of the learning unit.

2. The standard time estimation device according to claim 1,
wherein the representative value calculation unit calculates a median value of the past track record value in the pattern as the representative value of the real operating time of the pattern.

3. The standard time estimation device according to claim 1,
wherein, for the pattern in which a combination of values of each of the attributes is new, the representative value calculation unit calculates a median value of the real operating time in all of the past manufacture track records as the representative value of the pattern.

4. The standard time estimation device according to claim 1, further comprising:
a data processing unit which unifies, as one value, a plurality of values in the same attribute having same or similar characteristics relative to the real operating time,
wherein the patterning processing unit groups attributes of the product into a group that carries a meaning by the attributes being combined based on data after it has been processed by the data processing unit, and extracts all combinations of values of each of the attributes configuring the group as a pattern from a past manufacture track record.

5. The standard time estimation device according to claim 1,
wherein the learning unit learns, according to a definition in which a pre-created learning target has been designated, the standard time based on the past manufacture track record that coincides with the definition.

6. A standard time estimation method in a standard time estimation device which estimates a work time required for producing a product as a standard time of the product, comprising:
a first step of grouping attributes of the product into a group that carries a meaning by the attributes being combined, and extracting all combinations of values of each of the attributes configuring the group as a pattern from a past manufacture track record;
a second step of respectively calculating, for each of the patterns, a representative value of a real operating time based on the past manufacture track record;
a third step of learning the standard time based on the representative value for each of the calculated patterns; and
a fourth step of estimating the standard time of the product based on a learning result.

7. The standard time estimation method according to claim 6,
wherein, in the second step, a median value of the past track record value in the pattern is calculated as the representative value of the real operating time of the pattern.

8. The standard time estimation method according to claim 6,
wherein, in the second step, for the pattern in which a combination of values of each of the attributes is new, a median value of the real operating time in all of the past manufacture track records is calculated as the representative value of the pattern.

9. The standard time estimation method according to claim 6,
wherein, in the first step, data processing which unifies, as one value, a plurality of values in the same attribute having same or similar characteristics relative to the real operating time is executed, and
attributes of the product are grouped into a group that carries a meaning by the attributes being combined based on data after it has been processed by the data processing, and all combinations of values of each of the attributes configuring the group are extracted as a pattern from a past manufacture track record.

10. The standard time estimation method according to claim 6,
wherein, in the third step, according to a definition in which a pre-created learning target has been designated, the standard time is learned based on the past manufacture track record that coincides with the definition.
